(19) United States
(12) Patent Application Publication
(10) Pub. No.: US 2025/0054075 A1
(43) Pub. Date: Feb. 13, 2025

(54) DATA PIPELINE TO EXECUTE CONVERGENCE BASED AGRICULTURAL ACTIONS

(71) Applicant: Pairtree Intelligence Pty Ltd, Molong (AU)

(72) Inventors: Michael Bernard YOUNG, Leura (AU); Hamish John Scott MUNRO, Molong (AU); Felix Benjamin BENTER, Wollongong (AU); Craig Raymond ROBERGE, Freshwater (AU)

(73) Assignee: Pairtree Intelligence Pty Ltd, Molong (AU)

(21) Appl. No.: 18/797,647

(22) Filed: Aug. 8, 2024

Related U.S. Application Data
(60) Provisional application No. 63/518,418, filed on Aug. 9, 2023.

(51) Int. Cl. G06Q 50/02; G06Q 10/0633

(52) U.S. Cl. CPC G06Q 50/02; G06Q 10/0633

(57) ABSTRACT

A nondestructive data pipeline to execute convergence based agricultural actions is provided. A system receives, for storage in a buffer, raw data from a plurality of data feeds that are indicative of performance of agriculture on a farm. The system tags, prior to execution of a data translation process, the raw data with a plurality of identifiers. The system executes, with the raw data maintained in the buffer, the data translation process to map the raw data from a first one or more shapes into a second shape to generate a normalized data set. The system determines, responsive to detection of the error, an identifier tagged to a portion of the raw data in the buffer that corresponds to the portion of the normalized data set with the error. The system updates the normalized data set to remove the error.

### CROSS-REFERENCE TO RELATED APPLICATION

This application claims the benefit of priority under 35 U.S.C. § 119 to U.S. Provisional Patent Application No. 63/518,418, filed Aug. 9, 2023, which is hereby incorporated by reference herein in its entirety.

### BACKGROUND

Devices can collect data associated with agriculture. However, due to the increasingly large number heterogenous devices, it can be challenging for devices to reliably and accurately interface or exchange data with one another due to lack of compatibility, which can result in latencies or delays, or erroneous actions or functions performed by one or more of the devices based on the data.

### SUMMARY

Aspects of technical solutions disclosed herein can be directed to a nondestructive data pipeline to execute convergence based agricultural actions. To improve reliable and accurate exchange of data among heterogenous devices in order to reduce or eliminate erroneous actions or functions performed by one or more of the devices based on the data without introducing latency or delays, this technical solution can maintain raw data received from sensor devices and translated data, where the technology can tag the raw data with an identifier that allows the technology to efficiently re-translate a portion of the raw data feed in the event there is an error with the original translation. The technology can determine, generate or identify convergence-based insights in which a function can use input from different data sources to compute a metric, such as disease risk for a crop. To facilitate doing so, the technology can, for example, storing sensor data with temporal and geospatial tags to allow for queries of a metric over an arbitrary geographic polygon or arbitrary time interval (e.g., average temperature over the past 20 hours for a specific portion of a field).

The technology can use one or more application programming interfaces (APIs) to collect or receive data feeds. For example, the APIs can receive time-series data from internet of things (“IoT”) sensors that can be collated with non-time-series data from applications or public data sets in a geo-spatial and temporal approach. For example, the technology can create, identify, or otherwise establish a geo-boundary and execute a query, such as “Provide data about Paddock_X for Time_Window_Y.” In response to this query, the technology can show, render, or otherwise present weather data from weather stations, soil moisture data, livestock activity, crop activity and the satellite NDVI imagery. Thus, the technology can render static NDVI images and align the historic weather and soil data that affected that crop, thereby facilitating historic and comparative analysis of performance.

An aspect of this disclosure can be directed to a system of convergence based agricultural actions via a nondestructive data pipeline. The system can include a data processing system comprising one or more processors, coupled with memory. The data processing system can receive, for storage in a buffer, raw data from a plurality of data feeds that are indicative of performance of agriculture on a farm. The system can tag, prior to execution of a data translation process, the raw data with a plurality of identifiers. The system can execute, with the raw data maintained in the buffer, the data translation process to map the raw data from a first one or more shapes into a second shape to generate a normalized data set. The system can detect an error in a portion of the normalized data set. The system can determine, responsive to detection of the error, an identifier of the plurality of identifiers tagged to a portion of the raw data in the buffer that corresponds to the portion of the normalized data set with the error. The system can update, via a second data translation process on the portion of the raw data in the buffer that corresponds to the portion of the normalized data set with the error, the normalized data set to remove the error.

An aspect of this disclosure can be directed to a method of convergence based agricultural actions via a nondestructive data pipeline. The method can be performed by a data processing system comprising one or more processors coupled with memory. The method can include the data processing system receiving, for storage in a buffer, raw data from a plurality of data feeds that are indicative of performance of agriculture on a farm. The method can include the data processing system tagging, prior to execution of a data translation process, the raw data with a plurality of identifiers. The method can include the data processing system executing, the raw data maintained in the buffer, the data translation process to map the raw data from a first one or more shapes into a second shape to generate a normalized data set. The method can include the data processing system detecting an error in a portion of the normalized data set. The method can include the data processing system determining, responsive to detection of the error, an identifier of the plurality of identifiers tagged to a portion of the raw data in the buffer that corresponds to the portion of the normalized data set with the error. The method can include the data processing system updating, via a second data translation process on the portion of the raw data in the buffer that corresponds to the portion of the normalized data set with the error, the normalized data set to remove the error.

An aspect of this disclosure can be directed to a non-transitory computer-readable medium storing processor executable instructions for convergence based agricultural actions via a nondestructive data pipeline that, when executed by one or more processors, cause the one or more processors to receive, for storage in a buffer, raw data from a plurality of data feeds that are indicative of performance of agriculture on a farm. The instructions can cause the one or more processors to system can tag, prior to execution of a data translation process, the raw data with a plurality of identifiers. The instructions can cause the one or more processors to execute, with the raw data maintained in the buffer, the data translation process to map the raw data from a first one or more shapes into a second shape to generate a normalized data set. The instructions can cause the one or more processors to detect an error in a portion of the normalized data set. The instructions can cause the one or more processors to determine, responsive to detection of the error, an identifier of the plurality of identifiers tagged to a portion of the raw data in the buffer that corresponds to the portion of the normalized data set with the error. The instructions can cause the one or more processors to update, via a second data translation process on the portion of the raw data in the buffer that corresponds to the portion of the normalized data set with the error, the normalized data set to remove the error.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system of convergence based agricultural actions via a nondestructive data pipeline.

FIG. 2 depicts an example operation of a system of convergence based agricultural actions via a nondestructive data pipeline.

FIG. 3 depicts an example graphical user interface provided by a system to perform convergence based agricultural actions via a nondestructive data pipeline.

FIGS. 4A-4D depict example graphical user interfaces provided by a system to perform convergence based agricultural actions via a nondestructive data pipeline.

FIG. 5 depicts an example method for convergence based agricultural actions via a nondestructive data pipeline.

FIG. 6 depicts an example method for convergence based agricultural actions via a nondestructive data pipeline.

FIG. 7 is a block diagram illustrating an architecture for a computer system that can be employed to implement elements of the systems and methods described and illustrated herein, including aspects of the systems depicted in FIG. 1, FIG. 2, the graphical user interfaces depicted in FIG. 3 and FIGS. 4A-4D, and the processes or methods depicted in FIG. 5 and FIG. 6.

### DETAILED DESCRIPTION

Following below are more detailed descriptions of various concepts related to, and implementations of, methods, apparatus, and systems of convergence based agricultural actions via a nondestructive data pipeline. The various concepts introduced above and discussed in greater detail below may be implemented in any of numerous ways.

This disclosure is directed to systems, methods and apparatus of convergence based agricultural actions via a nondestructive data pipeline. For example, due to the exponential growth in technology adoption on agricultural farms, the devices used to collect or process devices may have different configurations, be of different types, use different formats, or utilize different services. As such, farms may double enter data from one medium to the other, or certain data may no longer be accessible to the age or compatibility of a device.

To improve reliable and accurate exchange of data among heterogenous devices in order to reduce or eliminate erroneous actions or functions performed by one or more of the devices based on the data without introducing latency or delays, aspects of the technical solutions disclosed herein can provide for streamlined and normalized data exchange in agriculture. Raw data from sensors, (e.g., IoT sensors), applications, satellite imagery, tractor telemetry or public data sources can be captured. The technology can maintain the raw data received from sensor devices and translated data, where the technology can tag the raw data with an identifier that allows the technology to efficiently re-translate a portion of the raw data feed in the event there is an error with the original translation. The technology can determine, generate or identify convergence-based insights in which a function can use input from different data sources to compute a metric, such as disease risk for a crop. To facilitate doing so, the technology can, for example, store sensor data with temporal and geospatial tags to allow for queries of a metric over an arbitrary geographic polygon or arbitrary time interval (e.g., average temperature over the past 20 hours for a specific portion of a field). This technology can provide a backend system architecture that can handle the dynamic requirements of an agricultural-specific integration engine.

This technology can be configured for or otherwise integrated for a data source. The technical solutions can include an integration that is customized or configured for each data source. A system of the technical solution can include an interface (e.g., an application programming interface “API”) that is designed, constructed or operational to receive from, transmit to, or otherwise exchange data with a data source. For example, the system can include an integration engine configured with a cron job (e.g., a time-based task scheduler that can be run as a background process) that can automatically perform or execute tasks, commands or scripts to automate data gathering. The cron job can leverage a message broker (e.g., an intermediary system or device) that facilitates communication between the different systems in order to send and receive messages to and from queues. The system can utilize a relational database management system to store the raw data using one or more components, tables, or functions. The system can utilize other types of databases, including, for example, a NoSQL database configured to handle unstructured or semi-structured data.

The system can normalize the raw data to expose the data in a geospatial and temporal view, regardless of whether the data was originally time series data. The system can provide access to this data, or otherwise utilize the data, via one or more APIs to generate actions based on functions applied to the data. The system can generate insights based on the data that can leverage mapping and visualization platform for geospatial and temporal services without end users having to establish a range of integrations or continually having to build new integrations. Thus, the technical solutions can create a singular endpoint where numerous data sets captured from various data sources can be normalized, maintained, and used to generate actions or otherwise provide insights.

Aspects of the technical solutions disclosed herein can provide various improvements, efficiencies, or new functionalities, including, for example, the ability to exchange data in a format that is compatible with APIs of the data sources, normalize and create data verticals that can reduce schemas, and focus on metrics. By centralizing data, this technical solution can converge data to create, generate, or determine new insights internally or for function-based API endpoints. The technical solution can store the raw data for buffering, redundancy, and re-calculations, thereby performing error correction in a more efficient manner by re-converting a tagged portion of the raw data.

The technical solutions can provide a security layer for a farmers' data as an intermediary by not unnecessarily exposing data. The technical solution can store the data geospatially and temporally (regardless of whether the data was time series or not), which can allow the system to execute queries such as, for example, “tell me the weather for that paddock (or within a radius) for the last 6 years,” where two completely different data sources have collected the data. In some cases, one or more aspects of this technical solution can be hosted on a clients' platform or link the clients' platform to the a server or cloud computing environment of this technical solution. The client device can request a trimmed results set to ingest desired portions of data, thereby reducing excessive network bandwidth utilization or memory consumption on the client device. The results set can create a dependency on the metric data sources used to deliver the results set.

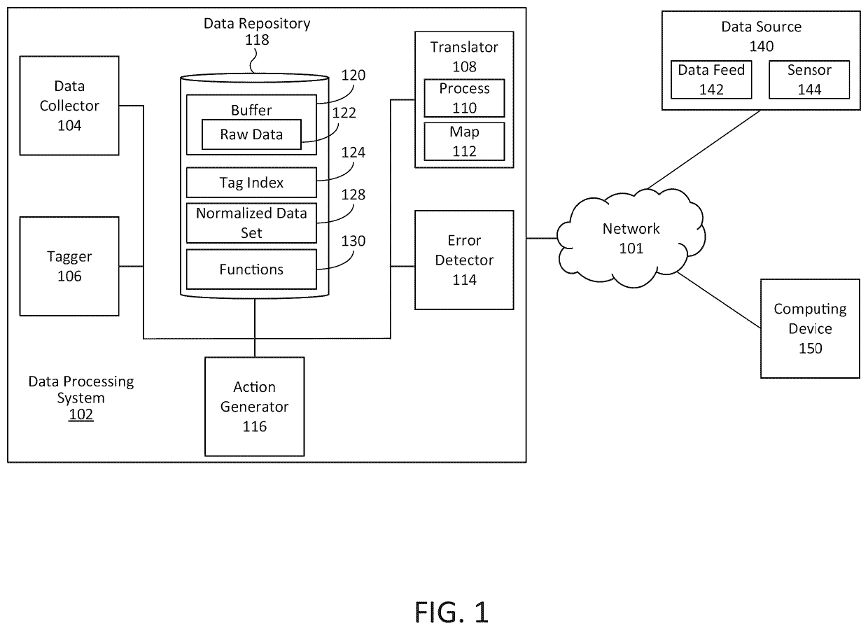

FIG. 1 depicts an example system 100 of convergence based agricultural actions via a nondestructive data pipeline. The system 100 can include a data processing system 102. The data processing system 102 can include a data collector 104 to receive, fetch, request, scrub, scrape, or otherwise obtain raw data from one or more data sources. The data processing system 102 can include a tagger 106 to apply a tag, identifier, flag, field, reference, or other indicator to one or more portions of data received by the data collector 104 from the one or more data sources 140. The data processing system 102 can include a translator 108 to execute data translation processes 110 or a map 112 (or schema) to convert or translate the raw data received from the data sources to normalized data. The data processing system 102 can include an error detector 114 to detect an error in a portion of the normalized data, and cause the data processing system 102 to remove the error. The data processing system 102 can include an action generator 116 to perform an action using a function in response to a request or query from a computing device 150.

The data collector 104, tagger 106, translator 108, error detector 114 or action generator 116 can each communicate with the data repository 118 or database. The data processing system 102 can include or otherwise access the data repository 118. The data repository 118 can include one or more data files, data structures, arrays, values, or other information that facilitates operation of the data processing system 102. The data repository 118 can include one or more local or distributed databases, and can include a database management system. The data repository 118 can include, store, maintain, or manage a buffer 120 that can include raw data 122. The buffer 120 can refer to or include a temporary storage area to hold raw data while it is being transferred from one place to another or while the raw data is being processed by the data processing system 102. The buffer 120 can be configured to improve the efficiency of data handling, prevent synchronization issues between different components of the data processing system 102 that may operate at different speeds or at different times, and allow the data processing system 102 to nondestructively transform, translate or convert the raw data in normalized data. The raw data 122 can refer to or include any information that can be obtained from data sources 140, including data feeds 142 or data from sensors 144.

The data repository 118 can include a tag index 124. The tag index 124 can refer to or include an index of tags that are applied, appended, concatenated or otherwise assigned to the raw data 122 that has been tagged by the tagger 106. The tag index 124 can include an identifier, tag, flag, or other symbol or indicator that maps or corresponds to a portion of the raw data 122. For example, the tag index 124 can include a reference or pointer to an address in memory or the buffer 120 that contains a portion of the raw data 122. The tag index 124 can include a starting address in memory and a size of the payload, or a starting and an ending address in memory that contains or stores a portion of the raw data 122 associated with the tag. The tag can include or indicate a unique identifier of the data, an identifier of a data source 140 that provided the data, a geographic indicator, a temporal indicator, or a geospatial tag, for example. The data repository 118 can include a normalized data set 128. The normalized data set 128 can refer to or include the output of the translator 108, which can be the translation of the raw data 122 based on a translation process 110 or a map 112 (e.g., a schema). The data repository 118 can include functions 130. Functions 130 can include scripts, programs, relations, logic, or rules that can be used to generate a response to a query or perform a convergence based action using the normalized data set 128.

The data processing system 102 can interface with, communicate with, or otherwise receive or provide information with one or more of a computing device 150, a data source 140 or a computing device 150 via a network 101. The data processing system 102, data source 140, or computing device 150 can each include at least one logic device such as a computing device having a processor to communicate via the network 101. The data processing system 102, data source 140, or computing device 150 can include at least one computation resource, server, processor or memory. For example, the data processing system 102 can include a plurality of computation resources or processors coupled with memory.

The network 101 can provide for communication or connectivity between the data processing system 102, computing device 150, and data source 140. The network 101 can include computer networks such as the Internet, local, wide, metro, or other area networks, intranets, satellite networks, and other communication networks such as voice or data mobile telephone networks. The network 101 can include wired or wireless networks, connections, or communication channels. The network 101 can be used to transmit or receive information or commands to or from various components or sources. The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network.

The computing device 150 can refer to or include a client computing device, such as a laptop computer, desktop computer, tablet, mobile device, wearable device, or telecommunications device. The computing device 150 can correspond to, host, or be included as part of a third-party platform. In some cases, the computing device 150 can be or include one of the data sources 140. The computing device 150 can be administered or operated by a farmer of the farm, a third-party platform, or a data feed 142 provider or data source 140 provider.

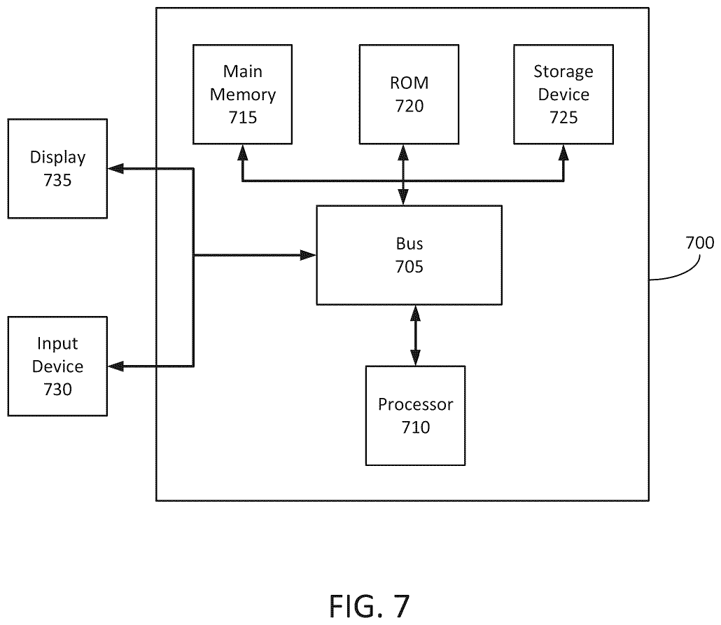

The computing device 150 can communicate with the data processing system 102 via network 101. The computing device 150 can include one or more component or functionality depicted in FIG. 7. The computing device 150 can transmit requests to the data processing system 102, receive responses from the data processing system 102, and output the responses via a display device or audio output, for example. The computing device 150 can input information or otherwise control the data processing system 102.

The remote data source 140 can refer to or include any source of data that can facilitate the data processing system 102 performing an action associate with a farm, growing crops, or raising livestock. Data sources 140 can include sources that can provide farm records, sensor data, farm management data, satellite imagery, or weather data, for example. Data source 140 can be configured with one or more APIs that can interface with a data collector 104 of a data processing system 102. Data sources 140 can be managed, maintained, operated by or otherwise administered by various entities. Data sources 140 can be hosted on one or more servers in a cloud computing environment. Data sources 140 can be local, computing devices located on a farm. Data sources 140 can include internet-of-things (IOT) enabled devices. Data sources 140 can include manually input data. Data sources 140 can include predicted or forecasted data or information, such as by a model trained using machine learning or other statistical or predictive technique. Data sources 140 can include historical data, real-time data, or static data. Data sources 140 can generate the data, or receive the data from other sources. Data sources 140 can include public data sources (e.g., data sources provided by public entities, government agencies, municipalities). Data sources 140 can include private data sources, such as companies, organizations, or individual entities. Data sources 140 can include satellites, applications, or geo-spatial data.

Data sources 140 can include, interface with, communicate with, or otherwise obtain data from a sensor 144. Sensor 144 can include or refer to any type of device, tool, probe, monitor, measurement device that can collect, sense, detect, or identify data associated with a farm that can facilitate performing an action. Sensors 144 can include, for example, one or more of a temperature sensor, light sensor, ambient light sensor, wind sensor, precipitation sensor, humidity sensor, or soil moisture probe. Multiple types of sensors 144 can be used or configured to provide data or generate data provided by the data feed 142. For example, multiple soil moisture probes can collect data that is used to provide a data feed 142, including, for example, a 10 centimeter soil moisture probe, a 20 centimeter soil moisture probe, and a 120 centimeter soil moisture probe.

The data source 140 can be configured with a mapping or index that can include a unique identifier for each sensor 144, and metadata or additional information that can facilitate providing a data feed 142 or downstream processing of the data feed 142 by the data processing system 102. The index can include, for each sensor 144, one or more of the type of sensor 144, a configuration of the sensor 144, a location of the sensor 144, an installation data of the sensor 144, an operator of the sensor 144, or other information that can facilitate identifying the sensor 144 or otherwise utilizing the data collected by the sensor 144. The index can include geospatial and temporal information about the sensors 144, or information that can facilitate executing functions or actions with geospatial and temporal components.

The sensors 144 can provide data to the data source 140 for transmission or provision via a data feed 142. The sensors 144 can convey the information to a data source 140 via a network 101 or hardwired connection. For example, the sensors 144 can include a network interface, which can be wired or wireless. The sensors 144 can communicate over any type of wireless or wired communication protocol.

Data sources 140 can, in some cases, process the data prior to providing the data to the data processing system 102. Data sources 140 can process the data by including an identifier for the source of the data, a timestamp for the data, or a geographic tag for the data. Data source 140 can process the data by removing or scrubbing aspects of the data, such as unique identifiers. For example, the data source 140 can anonymize a source of the data. Then data source 140 can remove or scrub aspects of the data to reduce a file size of the data or a size of the data feed 142 in order to reduce network bandwidth utilization or memory utilization. For example, the data source 140 can be configured with a technique or process to reduce excessive or wasted memory or network bandwidth utilization, and can execute the technique or process prior to providing a data feed 142.

Data sources 140 can include or provide a data feed 142. The data feed 142 can refer to or include a data stream or data feed service. The data feed 142 can refer to a mechanism in which data is delivered in real-time or near-real-time (e.g., responsive to identifying, receiving or generating the data). The data source 140 can provide the data feed 142 responsive to a request from the data processing system 102 (e.g., data collector 104). The data feed 142 can, in some cases, include a continuous stream of data that is updated based on a time interval (e.g., every 1 minute, 2 minutes, 5 minutes, 10 minutes, 15 minutes, 30 minutes, hourly, every 2 hours, every 6 hours, every 12 hours, every 24 hours, every 48 hours, every 72 hours, weekly, or other time interval). The time interval can vary based on the type of data or the type of source of the data. The time interval for a data feed 142 can be set or established in a configuration file for the data feed 142. The time interval can be based on a sampler rate for the data. The sample rate can be based on a sample rate of a sensor or monitor that detected, measured, or otherwise collected that data.

The data source 140 can provide different types of data feed. For example, a first data feed 142 can include a time series of data, and a second a second data feed 142 that can include a cross-sectional data. Time series data can refer to or include a type of data where observations are recorded at specific time intervals to form a sequence of data points ordered chronologically. In the time series data format, each data points can be associated with a timestamp, indicating the time at which the observation was made, received, recorded, or transmitted. The time series data can be collected over equally spaced time intervals, or irregular intervals. Thus, time series data can be arranged in a chronological order, have a sequential dependence (e.g., the value of a data point can be influenced by previous observations), have seasonality or display other patterns, have a trend (e.g., short-term or long-term trends), or may include noise (e.g., random variations or fluctuations). Examples of time series data can include temperature data, precipitation, light intensity, or soil moisture.

The data source 140 can provide a data feed 142 of data having a cross-sectional data type. Cross-sectional data can refer to or include a type of data that can be collected at a specific point in time. For example, cross-sectional data can represent a snapshot at a particular time, as opposed to time series data which can correspond to observations made over time. Thus, cross-sectional data can include a single point in time (e.g., providing a slice of information about a farm-related activity), have independent observations (e.g., each observation in cross-sectional data can be independent of others in the dataset), or may not have a temporal ordering (e.g., because cross-sectional data may not involve multiple observations over time). Examples of cross-sectional data can include, for example, biosphere data, biodiversity data, or property data.

Thus, the data source 140 can provide various types of data feeds 142 containing various types of information. Example data feeds 142 can include: weather forecast data, farm management data, livestock management data, biosphere data, biodiversity data, property data, river height data, or dam height data. Weather forecast data can refer to or include current or predicted weather information for a particular geographic area or region (e.g., a farm, town, city, zip code, or country). Weather forecast data can include temperature, precipitation, wind, humidity, atmospheric pressure, cloud cover, or weather phenomena. Farm management data can refer to or include crop and livestock data (e.g., information about the types of crops and livestock raised on the farm, planting dates, crop varieties, livestock breeds, health records, or performance metrics), soil data (e.g., soil characteristics, fertility, nutrient levels, pH), equipment data (e.g., farm machinery, maintenance schedules, fuel consumption, or operational efficiency), financial data, market data, yield datal, or pest and disease datal. Livestock management data can refer to or include information about animal health records, reproduction data, feeding and nutrition datal, growth and production data, identification and tracking, or livestock movements.

Biosphere data can refer to or include information or data sets related to living organisms in a zone on earth, such as the biodiversity data (e.g., information about the variety and variability of living organisms in different ecosystems and habitats, species richness, species abundance, distribution patterns), species records, ecological data, ecosystem data, climate and environmental data, remote sensing data, or phenological data. Biodiversity data can refer to or include species records, species diversity indices, distribution data, endemism data, ecosystem datal, genetic data, or ecological interactions.

Property data can refer to or include information about a particular farm or the property on which the farm is located. The property data can provide information regarding characteristics or attributes of the land or facilities on the land. Property data can include land information (e.g., layout of fields or paddocks, soil types, topography, or natural features present on the land), ownership information, water resources (e.g., wells, rivers, ponds, or irrigation systems), infrastructure (e.g., farm buildings, sheds, storage facilities, livestock housing), crop history (e.g., historical data about crops grown on the field, crop rotation practices, or yields), livestock capacity, environmental factors (e.g., weather patterns, frost dates, or climate characteristics), or pasture and forage data. Property data can be collected by data source 140 through a combination of data entry, field surveys, GPS mapping, remote sensing, and farm management software.

River height data can refer to or include river stage data or river level data, which can include information about water level of a river at a specific location and time. Water level can be measured in meters or feet above a reference point, and can represent a vertical distance between the water surface and a fixed benchmark. River height data can be measured using sensors such as river gauges, which can be installed at points along a river. River gauges can measure water level using pressure sensors, ultrasonic sensors, or staff gauges. Dam height data can refer to or include information about a vertical distance between a base or foundation of a dam and the crest or top surface of the dam. Dam height data can provide insight into physical characteristics and capacity of a dam. Dam height data can include dam crest elevation, dam base elevation, maximum water level, or spillway crest elevation.

The data source 140 can provide the data feed 142 over network 101 using one or more interfaces or mechanisms. The data source 140 can transmit the data feed 142 using an API. For example, the data processing system 102 (via data collector 104) can make a request to the API of the data source 140 in order to receive the data feed 142 or structured data in response. The data source 140 can be configured with a webhook, such as an HTTP callback, that can be triggered by an event, condition or other type of trigger. The data source 140 can use the webhook to deliver real-time updates when new data in the data feed 142 becomes available. The data source 140 can use a syndication format, such as an XML-based format to distribute data feed 142 updates. The data source 140 can be configured with messaging protocols (e.g., MQTT) to deliver data, such as real-time sensor data, from sensors 144 or devices.

The data processing system 102 or data source 140 can be part of or include a cloud computing environment. The data processing system 102 or remote data source 140 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous-one or more of the servers or machines can operate according to one or more type of operating system platform.

The data processing system 102 can include an data collector 104 designed, configured and operational to capture data from one or more remote data sources 140 via network 101, or otherwise communicate with one or more computing devices 150. The data collector 104 can integrate with various types of data sources 140. The data collector 104 can integrate with various verticals of data sources 140, including, for example, weather station supplies or soil probe provides. The data collector 104 can be designed, configured, constructed, or operational to receive and transmit information. The data collector 104 can receive and transmit information using one or more protocols, such as a network protocol. The data collector 104 can include a hardware interface, software interface, wired interface, or wireless interface. The data collector 104 can facilitate translating or formatting data from one format to another format. For example, the data collector 104 can include an application programming interface that includes definitions for communicating between various components, such as software components. The data collector 104 can be designed, constructed or operational to communicate with one or more data sources 140.

The data collector 104 (or data processing system 102) can be configured, customized, or otherwise tailored to integrate with each particular data source 140. For example, the data collector 104 can integrate or obtain data sources 140 of various types of quality, maturity, or stage of the source. Thus, the data collector 104 can be configured to use any data-gathering technique or mechanism. In some cases, the data collector 104 can utilize a cron job tool to automate data gathering that is stored in a database through a suite of tables or functions. For example, the data collector 104 can include an interface (e.g., an application programming interface “API”) that is designed, constructed or operational to receive from, transmit to, or otherwise exchange data with a data source 140. The data collector 104 include an integration engine configured with a cron job (e.g., a time-based task scheduler that can be run as a background process) that can automatically perform or execute tasks, commands or scripts to automate data gathering. The cron job can leverage a message broker (e.g., an intermediary system or device) that facilitates communication between the different systems in order to send and receive messages to and from queues. The system can utilize a relational database management system (e.g., data repository 118) to store the raw data 122 using one or more components, tables, or functions. The system can utilize other types of databases, including, for example, a NoSQL database configured to handle unstructured or semi-structured data.

The data collector 104 can receive data from electronic sources (e.g., remote data sources 140) associated or linked with a farm. The farm can refer to a physical farm that is established to grow one or more crops or raise livestock. The farm can have an address, location, or geographic coordinates. Information about the farm, including a profile, can be stored as farm records in data repository 118. The data collector 104 can capture the data from data sources 140, data feeds 142, sensors 144, equipment, cloud-computing data sources, ERP system, or any other data sources.

The data collector 104 can use various types of application programming interfaces (“APIs”) to capture, request, access, or otherwise receive data. For example, the data collector 104 can use an API to obtain data from the data source 140. The data collector 104 can be configured to make an API call in a protocol, format, or structure that is compatible with the data source 140. The data collector 104 can request data from multiple data sources 140, and construct the requests in the format that corresponds to each of the respective data sources 140. The data collector 104 can be configured with credentials (e.g., authentication credentials such as a username, password, digital security certificate, or token) to access private or secured data sources 140.

The data collector 104 can ping the data sources 140 for data based on a time interval, periodically, or responsive to an event, condition or other trigger. In some cases, the data collector 104 can establish a communication channel with the data sources 140 over network 101 in order to receive a data feed 142, such as a real-time data stream. The data collector 104 can receive raw data from one or more data feeds 142 that are indicative of performance of agriculture on a farm. The data collector 104 can store the raw data 122 from the data feed 142 in a buffer 120 in the data repository 118. The data processing system 102 can receive the data feeds 142 generated by sensors 144, which can include at least one of a precipitation sensor, a temperature sensor, a light sensor, a humidity sensor, a wind sensor, or a soil moisture probe, for example. The data processing system 102 can receive a data feed 142 from a satellite, which can include satellite imagery data, doppler data, radar data, or other data collected by a satellite that is in a geosynchronous orbit or otherwise orbiting the earth. The data processing system 102 can receive the data feeds 142 as a time series, snapshot, slices, or cross-sectional data.

The data processing system 102 can receive, in response to the request, the data in one or more formats. The data can include values, such as numerical values or numbers. The data can include alphanumeric values, characters, symbols or other indications. The data can be organized in various types of data structures or fields. The data can be stored as comma separated values, log files, text files, or data structures. The data collector 104 can store the raw data received via data feeds 142 in the buffer 120. By storing the raw data in the buffer 120, the data processing system 102 of this technical solution can establish a nondestructive data pipeline to execute convergence based agricultural actions.

The data collector 104 can receive a self-healing data feed 142 by using a rolling transaction window (e.g., 3 days) instead of obtaining only a last transaction of data. By using the rolling transaction window, the data collector 104 can resolve missing data or data that was not received due to network issues or sensor issues. The data collector 104 can store the raw data 122 as an observation table. When value changes, the data collector 104 can update the value in the observation table of the raw data 122. For example, a device can include multiple sensors. If a value of one of the sensors changes, then the data collector 104 can update the observation table stored in the raw data 122 with the updated sensor value. To do so, each sensor and corresponding value can be tagged in the raw data 122 with a handle, tag, or other unique identifier. When the data collector 104 receives a data feed 142 for that sensor 144, the data collector 104 can determine if the value is the same or has changed, and then update the value in the observation stored in the raw data 122. By only updating the raw data 122 when a value has changed, the translator 108 can determine to not re-normalize the raw data 122 every time a data feed 142 is received, but instead re-normalize the portion of the raw data 122 when there has been a change in a value in the raw data 122. Thus, the translator 108 may not translate the raw data 122 as the streamlining data feed 142 is received, but can translate the raw data 122 responsive to a request or a change in a value of the raw data 122.

The data processing system 102 can include a tagger 106 designed, constructed and operational to tag, prior to execution of a data translation process by the translator 108, the raw data 122 with a plurality of identifiers. The identifier can identify or indicate a source of the raw data, type of the raw data, or other identifying information of the raw data. In some cases, the unique identifier can include a hash value generated based on inputting a portion of the raw data into a hash function, which can generate unique has values. The tagger 106 can concatenate, combine, or otherwise append the tag (e.g., unique identifier) to a corresponding portion of the raw data for storage in the data repository 118 as tagged raw data. The tagged raw data can be stored or maintained in the buffer 120. For example, the tagged raw data can replace the raw data 122 initially stored in the buffer 120 upon receipt via data feed 142, or the tags can be applied to the raw data 122 and the raw data 122 can be referred to or include the tagged raw data.

The data processing system 102 can tag each portion of the raw data (or each portion of a data feed 142) with a unique tag or identifier. The tagger 106 can split up the data feed 142 received by the data collector 104 into one or more portions. The tagger 106 can split up the data feed 142 into different portions based on a source of the data feed 142, a time stamp or range of time stamps or time interval associated with the data, or a location associated with the data. In some cases, the tagger 106 can split up the data received by the data collector 104 into different portions based on file size, the amount of data, or a number of data values or entries. For example, tagger 106 can split up the data into portions that are equivalent or approximately equivalent (e.g., within 5%, 10% or 15%) in size (e.g., as measured in bytes, kilobytes, or megabytes). By splitting up the data received via the one or more data feeds 142 into different portions, the data processing system 102 can translate the different portions and, if an error is detected, re-translate the portion containing the error as opposed to re-translating an entire data set received from the data source 140, thereby reducing excessive computing resource utilization while maintaining accurate, reliable data translations and the effective and accurate performance of actions by the action generator 116 using the translated data. The data processing system 102 can tag the normalized data set with a geospatial identifier and a temporal identifier.

The tagger 106, upon generating or establishing the tags and assigning the tags to the raw data 122, can generate or establish a tag index 124. In some cases, tagging the raw data can refer to or include generating a tag index 124 without tagging or appending a unique identifier to the raw data 122 itself. Instead, and for example, the tagger 106 can establish a tag index 124 that includes a unique identifier and a pointer or reference to an address or location in memory or in the buffer 120 that contains the corresponding portion of the raw data 122. Thus, when the data processing system 102 detects an error or otherwise determines to re-translate or access raw data that has not been translated, the data processing system 102 can perform a lookup in the tag index 124 using the tag, and identify the corresponding portion of memory or buffer containing the portion of the raw data 122.

The data processing system 102 can include a translator 108 designed, constructed and operational to execute a translation process 110 or use a map 112 (e.g., a schema) to convert, translate, or otherwise generate a normalized data set 128 from, or based on, the raw data 122. For example, the translator 108 can use the data translation process 110 to map the raw data from a first one or more shapes into a second shape to generate a normalized data set 128. The translator 108 can execute the translation process 110 on the raw data 122 while maintaining the raw data 122 in the buffer 120. For example, the translator 108 can execute the translation process 110 to create the normalized data set 128 without removing, modifying, adjusting, or altering the raw data 122 stored in the buffer 120. Thus, the translator 108 can establish a nondestructive data pipeline to execute convergence based agricultural actions.

The translator 108 can normalize the data in accordance with a schema (e.g., a map 112). The translator 108 can perform a functions-based translation (e.g., a process 110). IN the functions-based translation, the data can be transformed to a particular standard, or the transformation can refer to computing new data value by performing an operation on the raw data, such as A+B−C=D.

The translator 108 can normalize the data responsive to a request to perform an action. The translator 108 can normalize the data responsive to receipt of the data feed 142 or data stream. The translator 108 can normalize the data responsive to a request, instruction, or command to generate a normalized data set. The translator 108 can receive the request, instruction or command to generate the normalized data set from a computing device 150, or one or more component of the data processing system 102. The translator 108 can normalize the raw data to expose or provide access to the data at a geospatial and temporal view, regardless of whether the raw data was time series data.

To generate the normalized data set 128 from the raw data, the translator 108 can select a normalization technique or process 110. The normalization technique or process 110 can leverage or utilize a map 112. Normalization processes 110 can include, for example, min-max scaling, z-score standardization (e.g., scale the data to have a mean of 0 and a standard deviation of 1), or log transformation. Normalization processes 110 can include, for example, converting the data into a same unit (e.g., metric units, such as Celsius for temperature, meters for distance, and kilograms for mass).

To generate the normal data set 128 from the raw data 122, the translator 108 can map binary strings or hexadecimal data. Each data feed 142 can use a different computer architecture or byte order. For example, the data feed 142 can have a little endian byte order in which the least significant byte (LSB) of a multi-byte data type can be stored at the lowest memory address in the buffer 120, while the most significant byte (MSB) can be stored at a higher memory address. Thus, the least significant part of a binary number can be stored first, and the most significant part of the binary number can be stored last. In some cases, the data feed 142 can have a big endian byte order, in which the most significant byte can be stored at the lowest memory address and the least significant byte can be stored at a higher memory address.

The data feed 142, or raw data 122 stored in buffer 120 received from a data feed 142, can include little endian data order in which a first byte of data corresponds to temperature, a second byte correspond to wind, and a third byte corresponds to direction. The translator 108 can use a process 110 to convert the raw data 122 to a normalized data set 128 in accordance with a map 112. For example, the map 112 can map a byte order from little endian to a big endian byte order.

In some cases, the data feeds 142 from different data sources 140 can have different shapes. The data can have different shapes. The shape of the data can refer to or include a different number of rows in a data set, a different number of columns in a data set, a different dimensionality, different data types, or different data distributions (e.g., different sample rates for time series data or different time windows). If data feeds 142 have different data shapes, the translator 108 can select a normalization process 110 that can perform one or more of data alignment, data merging, or data transformation in order to normalize the data sets from the different data feeds 142 of the different data sources 140 such that the data sets are compatible with one another, and allow for the performance of convergence-based actions by the action generator 116.

The data processing system 102 can perform non-destructive procedures on the raw data that creates a logical copy or representation of the original data through using processes that can include, for example, one-to-one mapping functions, many-to-one mapping functions or one-to-many mapping functions. The data processing system 102 can store, provide, or manipulate parameters of the mapping functions through a variety of techniques via the end user, data provider (supplier) or an administrator of the data processing system 102.

The data processing system 102 can include an error detector 114 designed, constructed and operational to detect an error in a portion of the normalized data set 128. Responsive to the detection of the error, the data processing system 102 (e.g., error detector 114) can determine an identifier of the multiple identifiers tagged to a portion of the raw data 122 in the buffer 120 that corresponds to the portion of the normalized data set 128 with the error. The data processing system 102 can cause the translator 108 to update, via a second data translation process 110 on the portion of the raw data 122 in the buffer that corresponds to the portion of the normalized data set 128 with the error, the normalized data set 128 to remove the error.

The error detector 114 can be configured with or utilize one or more techniques to detect, determine, or otherwise identify errors in the normalized data set 128. The error detector 114 can, in some cases, detect the error during the translation process. For example, the translator 108 can execute a translation process 110 and detect an error, alert, or system event during the translation. The translator 108 can log the error event in a log file. The error detector 114 can access and parse the log file to identify the error.

The error detector 114 can parse, search, or otherwise analyze the normalized data set 128 to identify an error. For example, an error can refer to a value in the normalized data set 128 being outside a predetermined or acceptable range of values for a type of data. For example, if the type of data is soil temperature, then the error detector 114 can compare the value in the normalized data set 128 with a predetermine range of acceptable values for soil temperature for a particular geographic region to determine whether the translated value satisfies or is within the predetermined range. If the translated value is not within the predetermined range, then the error detector 114 can generate an alert, command, instruction or otherwise flag the error. For example, if the soil temperature value in the translated data set is 100 degrees Celsius, the error detector 114 an determine that the value is outside a predetermined range of 7 degrees Celsius to 27 degrees Celsius. The error detector 114 can establish the predetermined range based on historical data obtained for the type of value.

The error detector 114 can perform data profiling, comparisons with the raw data, data consistency checks, or integrity checks to determine or identify an error. For example, the error detector 114 can compare the translated value with the value in the raw data to determine if there is a match. The error detector 114 can perform a data consistency check to determine whether values for the same type of data that are geospatially and temporally proximate to one another are consistent or do not vary beyond a threshold amount. For example, the values for soil temperature on a particular paddock may not change more than a threshold number of degrees Celsius in a time interval (e.g., soil temperature 50 centimeters deep may be unlikely to change more than 2 degrees Celsius over 12 hours). The error detector 114 can perform a data integrity check to determine whether the translation process did not introduce data integrity issue, such as duplication, missing values, or data truncation in the translated data set. The error detector 114 can determine that there is a null value in the translated data set, and determine that the null value corresponds to an error. The error detector 114 can determine that a shape of a translated data set is erroneous if it does not match a predetermined shape or otherwise correspond to a shape of the raw data.

The error detector 114 can determine the portion of the translated data with the error. The error detector 114 can convey the portion of the translated data with the error to the translator 108 to cause the translator 108 to re-translate the erroneous portion. The error detector 114 can provide an identifier of the translated portion of the data that corresponds to the error. The identifier, or tag, can correspond to the identifier or tag applied by the tagger 106. Thus, the error detector 114 can determine than error exists in the translated data, and provide an indication of which values or portions of the data set contain the error.

The translator 108, upon receiving the alert or indication of the error from the error detector 114, can use the tag or identifier to access the raw data 122 stored in the buffer 120. For example, since the translator 108 translated the raw data 122 to generate the normalized data set 128 while maintaining the raw data 122 in the buffer 120 pursuant to the nondestructive pipeline, the translator 108 can access only a portion of the raw data 122 based on the tag. For example, the translator 108 can perform a lookup in the tag index 124 with the tag received from the error detector 114 to determine an address in the memory or buffer 120 that corresponds to the portion of the raw data 122 to be translated. The translator 108 can access the portion of the raw data 122 to execute a second translation process 110.

To retranslate the portion of the raw data that corresponds to the detected error, the translator 108 can either use the same translation process 110, or select a second or different translation process 110. For example, the translator 108 can determine that the first translation process 110 used to initially translate the portion of the raw data 122 was not compatible with the raw data or otherwise cause the error, and the translator 108 can select a second translation process 110.

In some cases, the translator 108 can be configured with multiple translation processes 110. The multiple translation processes 110 can be different from another, use different maps 112, different rules, or different logic. In some cases, the multiple translation processes 110 can be ranked based on a priority or order. The translation processes 110 can be ranked based on computing resource utilization or accuracy. The translation processes 110 can be ranked based on a score that takes into account both the computing resource utilization used for the translation process 110 and the accuracy of the translation process 110. For example, a second translation process 110 that utilizes the most computing resources (e.g., hardware processor utilization or memory utilization) and may be the most accurate may be ranked lower than a first translation process 110 that utilizes 50% of the computing resources as compared to the second translation process 110, but is 80% as accurate as the second translation process 110.

Thus, responsive to receiving the indication of the error, the translator 108 can select a different translation process 110 or map 112. The translator 108 can select a second translation process 110 that may utilize greater computing resources (e.g., process and memory), but may result in increased accuracy or be configured to handle the type of error identified by the error detector 114. For example, the translator 108 can select a second translation process 110 responsive to or based on the type of error that was detected by the error detector 114. For example, the error detector 114 can provide an indication to the translator 108 of the type of error detected in the translated data, and the translator 108 can select a process 110 that is configured to address the type of error. The translator 108 can include an index or mapping of types of errors to processes 110 or maps 112 configured to address the type of error or pre-empt the type of error.

The translator 108 can execute the selected process 110, and then update the normalized data set 128 in the data repository 118 with the corrected, re-translated portion of the data set. By re-translating only the portion of the data set with the error, the translator 108 can reduce computing resources consumption as compared to re-translating the entire set of raw data. By detecting and correcting errors in the normalized data set 128 using only the corresponding portion of the raw data 122 stored in the buffer 120 via the tag, the data processing system 102 of this technical solution can improve the reliability, accuracy or efficiency with which actions can be performed without excessive re-translation or computing and memory utilization.

The data processing system 102 can include an action generator 116 designed, constructed and operational to perform an action based on, utilizing, or responsive to the normalized data set 128. The data processing system 102 (e.g., action generator 116) can receive, via the network 101 from a computing device 150 remote from the data processing system 102, a query to generate a metric indicative of performance of a farm. The computing device 150 can correspond to, host, or be included as part of a third-party platform. In some cases, the computing device 150 can be or include one of the data sources 140. The computing device 150 can be administered or operated by a farmer of the farm.

The action generator 116 can parse the query to determine an action to perform responsive to the query. The query can include an indication of the action to perform. The query can include an identifier, name, keyword, terms, or phrase corresponding to the action. For example, the action can be to determine a metric corresponding to performance of an activity on a farm. The action can be to adjust or control an activity being performed on the farm to improve performance on the farm. The action can be to perform or schedule an activity to be performed on the farm.

The action generator 116 can receive a query data structure with a geospatial component and a temporal component. For example, the query data structure can include the type of metric to compute, a geospatial area or region for which to compute the metric (e.g., a specific farm, a portion of a farm, or a paddock), and a timestamp or time interval over which to compute the metric.

Responsive to the query to generate a metric, the action generator 116 can select a function 130 to generate the metric. The action generator 116 can perform a lookup in the functions 130 data structure to select a function 130 configured to generate the metric. For example, the metric can correspond to disease risk for a particular crop grown or to be grown on the farm. The action generator 116 can select the function 130 that can output the disease risk metric. In another example, the query can include input fields and a request output metric. The action generator 116 can select the function 130 that is configured for the input fields provided in the query, and the generate the corresponding output metric.

In some cases, the action generator 116 can identify the function comprising inputs corresponding to data obtained from multiple data feeds 142. The multiple data feeds 142 can be provided by one or more data sources 140.

The action generator 116 can apply the function to the normalized data set 128 to generate the metric. In some cases, the action generator 116 can instruct, command, or otherwise cause the translator 108 to translate the portion of the raw data 122 responsive to receiving the query. For example, rather than translating raw data 122 as a data feed 142 is received in real-time, the translator 108 can perform the translation of the raw data 122 responsive to receiving the query to generate the metric. The action generator 116 can select, for input into the function and based on the query data structure, one or more portions of the normalized data set. The portions of the normalized data set input into the selected function can be obtained from a single data feed 142, multiple data feeds 142 provided by a single data source 140, or multiple data feeds 142 provided by multiple data sources 140. The data processing system 102, by storing the raw data 122 in buffer 120 and generating a normalized data set 128 via translator 108, can utilize functions that process data from multiple, heterogenous data sources 140 or data feeds 142 to execute a convergence-based action via a nondestructive data pipeline. The action can be a convergence based action by leveraging multiple different types of data, data feeds 142, or data sources 140.

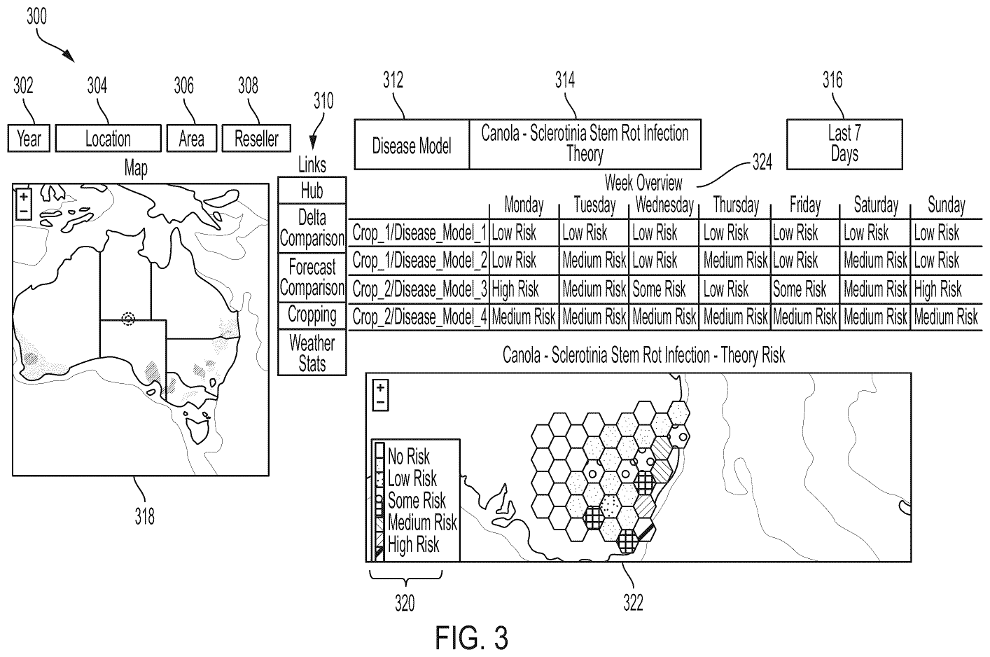

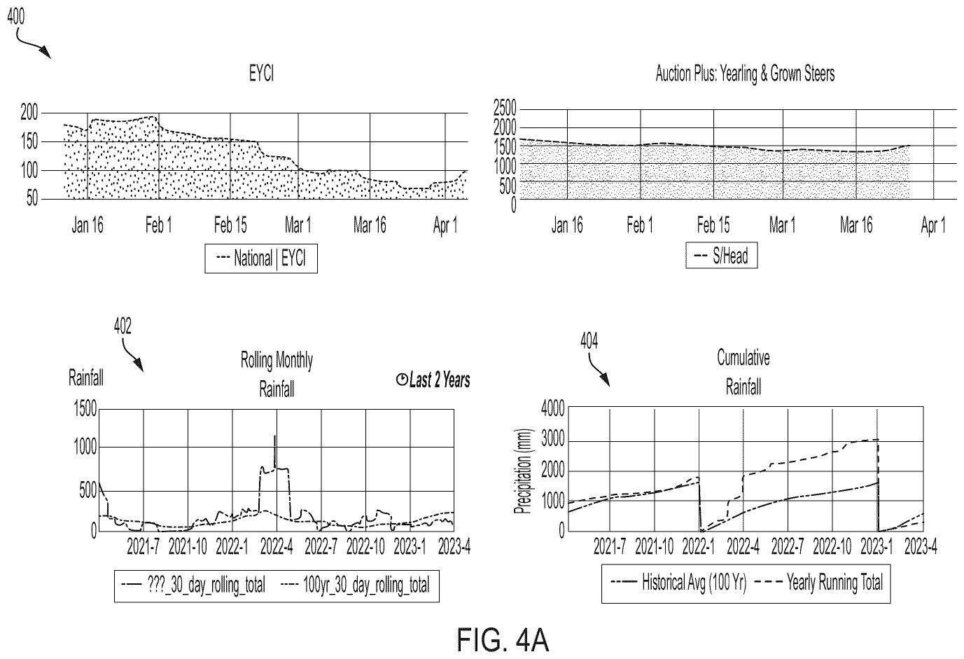

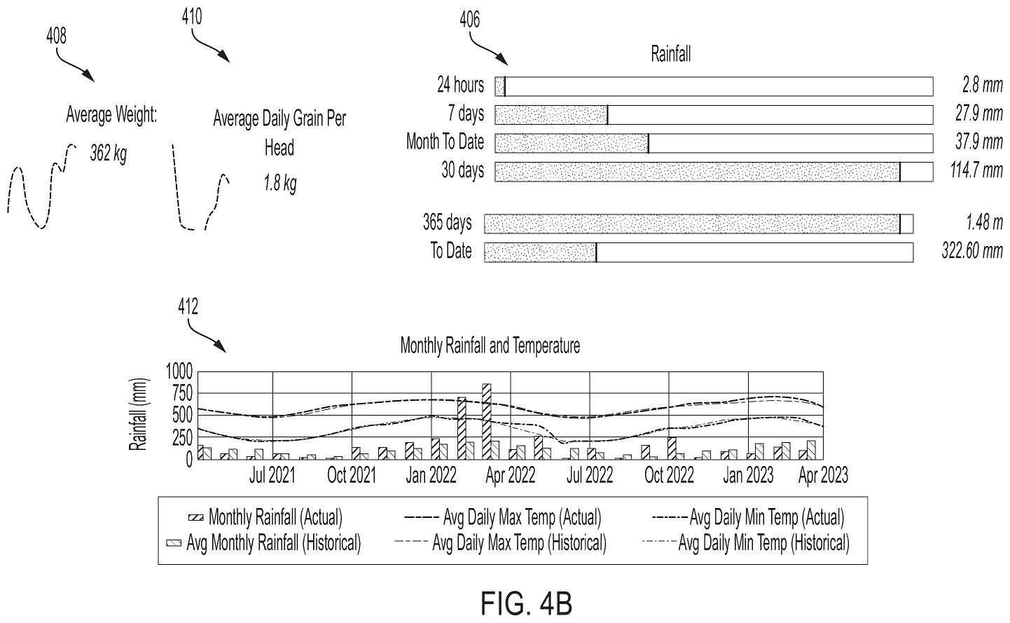

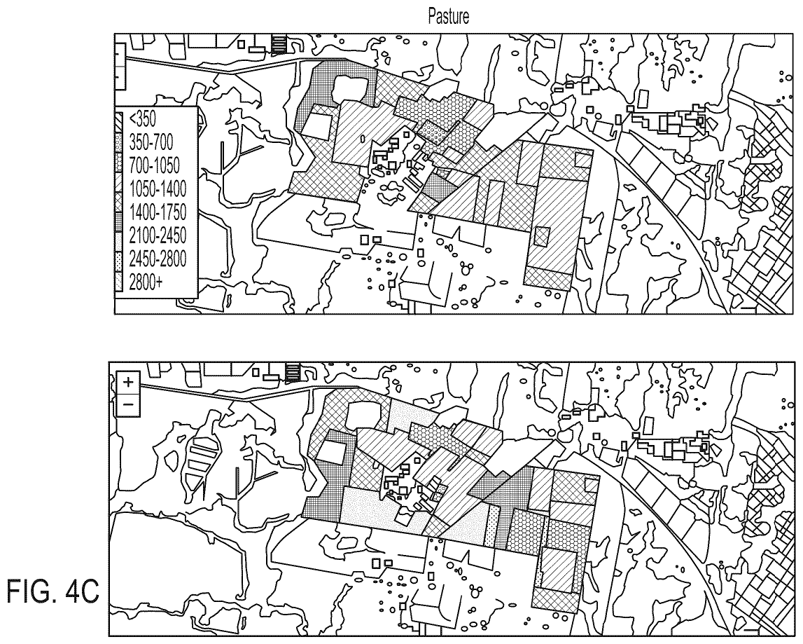

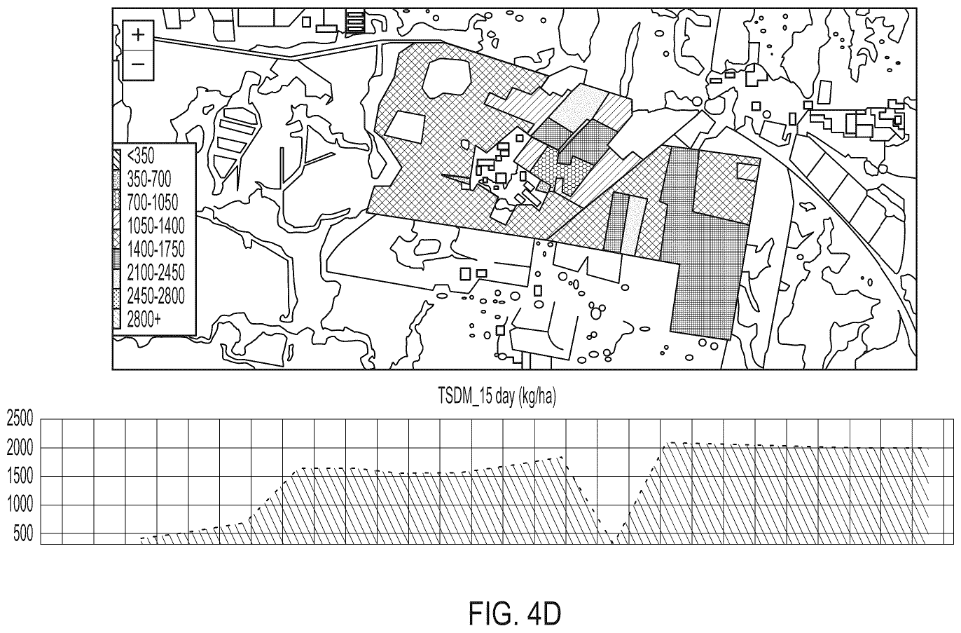

The action generator 116 can provide the metric for display via the computing device 150 or other device that requested the action to be performed. The data processing system 102 can provide the metric for display via a graphical user interface. The data processing system 102 can provide any type of visualization (e.g., GUI 300 depicted in FIG. 3 or GUI 400 depicted in FIGS. 4A-4D), including text, numbers, symbols, tables, charts, graphs, or images. The data processing system 102 can provide a dynamic or interactive report or output. For example, a computing device 150 can interact with the graphical user interface to modify or control the output or report.

The action generator 116 can provide the metric via a data transmission, data packets, electronic message, or other communication mechanism. The action generator 116 can provide the metric to the computing device 150, to a third-party platform, or a data source 140. For example, the data processing system 102 can provide the metric to the device or entity that provided the query, or the query can include an indication or instruction with an address to which to forward the generated metric.

For example, the data processing system 102 can receive a query to determine a disease risk for a particular type of crop or all crops on a particular farm for a particular growing season. The data processing system 102 can select a function configured to determine the disease risk for the crop of the farm. The data processing system 102 can determine one or more geospatial and temporal inputs for the function. For example, the geospatial input can correspond to latitude and longitude coordinates of the farm, an address, a zip code, or another geographic region or geopolitical boundary. The data processing system 102 can access, from the normalized data set 128, data corresponding to the one or more geospatial and temporal inputs for the function. In some cases, the data processing system 102 can translate the portion of the raw data 122 corresponding to the inputs for the function to generate the corresponding portion of the normalized data set 128. The data processing system 102 can input the portion of the normalized data set 128 data into the function to generate a metric corresponding to the disease risk for the crop of the farm. The data processing system 102 can provide, for display via a device, the metric.

The data processing system 102 can receive queries for various types of metrics, including, for example, frost modeling, compliance, productivity, integrity, or stewardship. For example, the data processing system 102 can receive a query such as “Provide data about Paddock_X for Time_Window_Y.” In response to this query, the data processing system 102 can show weather data from weather stations, soil moisture data, livestock activity, crop activity and the satellite NDVI imagery. NDVI can refer to normalized difference vegetation index, and can be represent the health and vigor of vegetation in remote sensing and satellite imagery. NDVI index can convey changes in vegetation over time.

The data processing system 102 can utilize one or more both of real-time and scheduled non-destructive mapping functions to generate a normalized logical copy of the original, raw data. The data processing system 102 can retrieve the normalized logical copy in a variety of ways, and transform the normalized logical copy into different formats, dependent on the querying function. The function parameters can be stored, provided and manipulated through a variety of means by the end user, data provider (supplier) or administrator of the data processing system 102. For example, the data processing system 102 can receive raw data indicating the sampled water volume for various heights of a dam. The data processing system 102 can use a polynomial regression to generate a curve to interpolate and extrapolate this data, from which the data processing system 102 can calculate the resulting volume of the water in the dam at a given height, based on a user-supplied parameter.

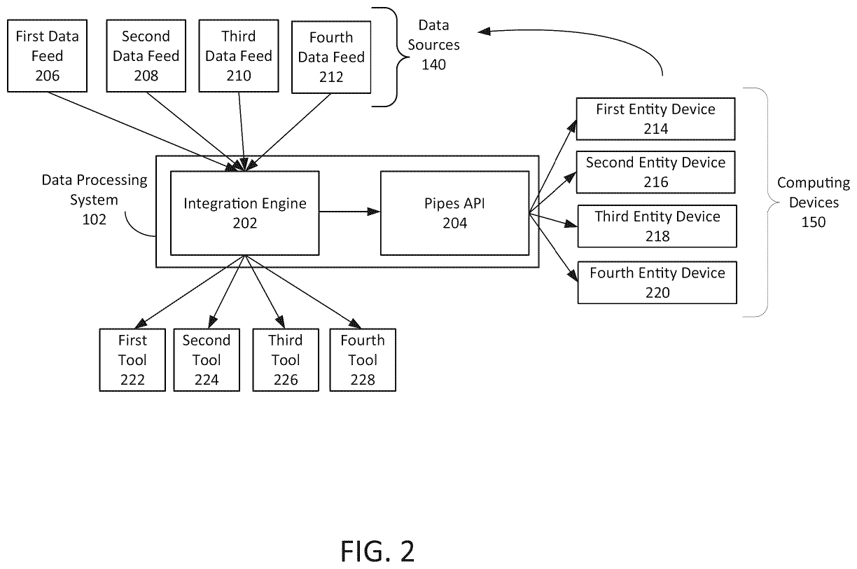

FIG. 2 depicts an example operation of a system of convergence based agricultural actions via a nondestructive data pipeline. The operation 200 can be performed by one or more system or component depicted in FIG. 1 or FIG. 7, including, for example, a data processing system, data sources, or computing devices. For example, the data processing system 102 depicted in FIG. 1 can include an integration engine 202 and a pipes API 204. The one or more components of data processing system 102 depicted in FIG. 1 can form or represent the integration engine 202 and pipes API 204, or the functionality thereof. The data feeds 206-212 can include one or more component or functionality of data feeds 142 depicted in FIG. 1. The entity devices 214-220 can include one or more component or functionality of computing device 150 depicted in FIG. 1.

The integration engine 202 (e.g., data processing system 102) can receive data from multiple data feeds, including a first data feed 206, a second data feed 208, a third data feed 210, and a fourth data feed 212, for example. The data feeds 206-212 can be from a same data source, or multiple different data sources (e.g., data sources 140). The integration engine 202 can tag the data received from the data feeds, and store the data in a buffer (e.g., raw data 122 stored in buffer 120). The integration engine 202 can provide the raw data or normalized data to the pipes application user interface 204, which can provide the data to one or more entities, such as a first entity device 214, a second entity device 216, a third entity device 218, or a fourth entity device 220. The data provided via pipes API 204 can be raw data, normalized data (e.g., pursuant to a map or schema) or functions based transformation (e.g., pursuant to a standard, or computed), or widgets (e.g., graphs and visualizations) of data sets. The entity devices 214-220 can correspond to or be operated by third-parties, such as an agricultural technology entity, and agricultural business entity, a software developer entity, a consultant entity, or a government agency entity. The entity devices 214-220 can query the data processing system 102 for data. The entity devices can go through authentication and security layers to obtain the data from data processing system 102. One or more of the entity devices 214-220 can be data sources 140, and provide one or more of the data feeds 206-212.

The data processing system 102 can provide or perform actions via tools, such as first tool 222, second tool 224, third tool 226 or fourth tool 228. The tools 222-228 can perform actions, provide graphical user interface, geospatial and temporal visualizations, provide dynamic reports, or otherwise execute or perform a function or action based on the data feeds.

Thus, the system 200 (or data processing system 102) can connect with multiple and various agricultural technology companies to provide geospatial and temporal visualizations for computing devices without the computing devices having to build connected software services.

FIG. 3 depicts an example graphical user interface provided by a system to perform convergence based agricultural actions via a nondestructive data pipeline. The graphical user interface (GUI) 300 can be provided by one or more system or component depicted in FIG. 1, FIG. 2, or FIG. 7, including, for example, a data processing system 102. The GUI 300 can be rendered or provided responsive to a query, such as a query to show the disease risk for a crop such as canola in a south eastern region of Australia. For example, the action generator or pipes API of data processing system can provide the GUI 300. The data processing system can display a map 318 and a map 322 through the GUI 300. The map 318 can include a geographic area with an overlay that can indicate performance associated with agriculture. The map 322 can indicate areas with disease risk, such as canola—sclerotina stem rot infection. The GUI 300 can include a legend 320 that shows no risk to high risk based on a gradation or color spectrum. The spectrum of risk in the legend 320 can include discrete levels, such as no risk, low risk, some risk, medium risk, or high risk. The data processing system can provide information about the year 302, location 304, area 306 or reseller 308. The data processing system can provide information about the disease model 312, such as canola—sclerotina stem rot infection (314). The data processing system can provide a week overview table 324 for the last time interval 316 (e.g., last 7 days) of the disease risk for each type of crop and using different types of disease models. The table 324 can depict different levels of risk determined for each of the crops and time periods based on functions and using data feeds. For example, the table 324 can depict a Low Risk of disease on Monday for crop_1 using disease-model_1, while showing a high risk for crop_2 using disease_model_3, for example.

The GUI 300 can reflect data feeds from numerous weather stations (e.g., 16 weather stations) to connect and re-calibrate a disease model to make insights-hyper-local for a farmer, or an area-wide management for an agronomist. The dots illustrated in map 318 can represent a weather station data source, and the circles represented in map 318 can represent crops on farms. The links 310 menu can drive the panel on the right of the GUI 300 for specific data request from the highlighted area on the map 318. From example, a user can select the area on the map 318 that is of interest, and the data processing system can collect data feeds for the corresponding geospatial area and temporal window 316. The data processing system can use the select data to generate the output map 322 and table 324.

FIGS. 4A-4D depict example graphical user interfaces provided by a system to perform convergence based agricultural actions via a nondestructive data pipeline. The GUI 400 can illustrate performance associated with raising livestock. The GUI 400 can illustrates a dashboard (e.g., depicted in FIGS. 4A-4D) that can display disparate, heterogenous data sources or data feeds as a time series. The dashboard can show additional metrics or information, such as markets, weight gain, weather, or pasture biomass. For example, the dashboard 400 can reflect a rolling monthly rainfall 402, a cumulative rain fall 404, a rain fall 406, and a monthly rainfall and temperature graph 412. The dashboard 400 can display information relating to livestock, such as the Eastern Young Cattle Indicator, an Auction Plus: Yearling & Grown Steers, the average weight 408 of the livestock, or the average daily grain per head 410 of the livestock. The dashboard 400 can illustrate a farm or plot of land. The dashboard can illustrate the total standing dry matter (TSDM) in kg/ha.

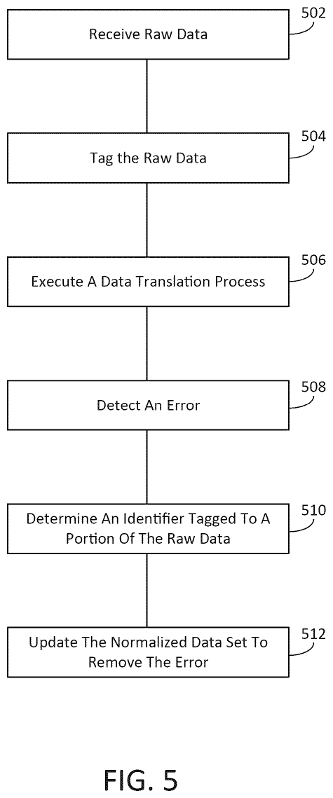

FIG. 5 depicts an example method for convergence based agricultural actions via a nondestructive data pipeline. The method 500 can be performed by one or more component or system depicted in FIG. 1, FIG. 2, or FIG. 7, including, for example a data processing system. At ACT 502, the data processing system can receive raw data. The data processing system can receive the raw data via one or more data feeds from one or more data sources. The data feeds can be from disparate data sources or heterogenous data sources. The data feeds can include time series data or cross-sectional data. The data feeds can be provided in real-time data streams, batch mode, or responsive to a request by the data processing system for data. The data processing system can store the raw data in a buffer or memory of the data processing system.

At ACT 504, the data processing system can tag the raw data. The data processing system can apply any type of tag or identifier to the raw data. The tag or identifier can indicate a data source of the data feed, a type of the data feed, geospatial or temporal information of the data feed. The data processing system can split up the data feed into separate portions, and apply a different tag to each portion. The data processing system can establish a tag index that includes a tag identifier and a pointer or reference to a portion of memory in which the raw data is stored.

At ACT 506, the data processing system can execute a data translation process. The data translation process can be to normalize the data pursuant to a schema or a map. The translation process can be to transform the data based on a function. The data translation process can translate data from multiple data feeds into a common or standardized data format such that the data processing system can perform actions on the data that converges or uses data from combined data feeds. The data processing system can translate the data without adjusting, modifying, or deleting the raw data in the buffer, thereby establishing a nondestructive data pipeline to perform convergence-based actions.

At ACT 508, the data processing system can detect an error in a portion of the data translation. The data processing system can use any error detection technique to determine the error, including, for example, a consistency check, null value check, or range check. Upon detecting the error at ACT 508, the data processing system can determine an identifier tagged to a portion of the raw data at ACT 510. The data processing system, at ACT 512, can use the identifier of the tag to access the raw data corresponding to the erroneous portion of the translated data to re-translate the data. The data processing system can update the normalize data set to remove the error at ACT 512.

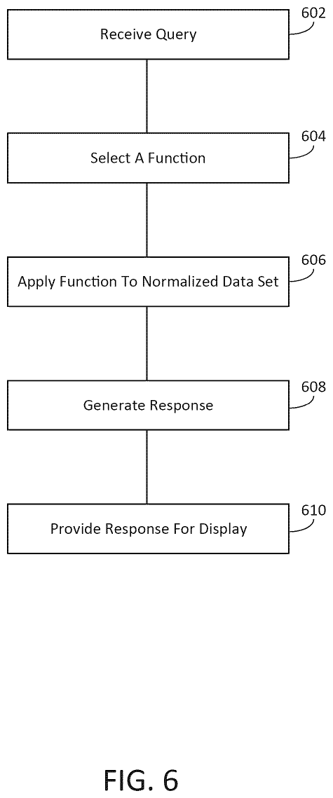

FIG. 6 depicts an example method for convergence based agricultural actions via a nondestructive data pipeline. The method 600 can be performed by one or more component or system depicted in FIG. 1, FIG. 2, or FIG. 7, including, for example a data processing system. At ACT 602, the data processing system can receive a query. The query can be to perform a convergence-based action, generate a metric, or provide a visualization, for example. The data processing system can receive the query from a computing device over a network. The data processing system can receive the query from a third party entity, a data source, a consultant, or other entity.

At ACT 604, the data processing system can select a function. The data processing system can select a function to execute the query or generate a response to the query. The data processing system can select the function based on the type of query, the inputs of the query, or the outputs of the query. For example, if the query is to generate a disease risk for a crop, the data processing system can select a function that takes, as its input, data feeds that can generate a disease risk metric for the crop.

At ACT 606, the data processing system can apply the function to the normalized data set. The data processing system can translate the raw data responsive to the query and selecting the function. The data processing system can determine the data or data feeds used to generate the metric, and access the corresponding portions of the data in the data repository. The data processing system can translate the portions of the data feeds that are used by the function to generate the metric. By not translating the entire data set or data feeds, the data processing system can, in some cases, reduce computing resource utilization and memory consumption.

At ACT 608, the data processing system can generate a response based on the query and the output of the function. The response can include a metric, notification, alert, or other message. The response can include graphical user interface, dashboard, interactive dashboard, or interactive and dynamic report. At ACT 610, the data processing system can provide the response for display (e.g., via GUI 300 or GUI 400).

FIG. 7 depicts an example block diagram of an example computer system 700. The computer system or computing device 700 can include or be used to implement a data processing system or its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be used for storing information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system of convergence based agricultural actions via a data pipeline, comprising:
a data processing system comprising one or more processors, coupled with memory, to:
receive, for storage in a buffer, raw data from a plurality of data feeds that are indicative of performance of agriculture on a farm;
tag, prior to execution of a data translation process, the raw data with a plurality of identifiers;
execute, with the raw data maintained in the buffer, the data translation process to map the raw data from a first one or more shapes into a second shape to generate a normalized data set;
detect an error in a portion of the normalized data set;
determine, responsive to detection of the error, an identifier of the plurality of identifiers tagged to a portion of the raw data in the buffer that corresponds to the portion of the normalized data set with the error; and
update, via a second data translation process on the portion of the raw data in the buffer that corresponds to the portion of the normalized data set with the error, the normalized data set to remove the error.

2. The system of claim 1, comprising:
the data processing system to receive the plurality of data feeds generated by a plurality of sensors comprising at least one of a precipitation sensor, a temperature sensor, a light sensor, a humidity sensor, a wind sensor, or a soil moisture probe.

3. The system of claim 1, comprising:
the data processing system to receive at least one of the plurality of data feeds from a satellite.

4. The system of claim 1, comprising:
the data processing system to receive a first data feed of the plurality of data feeds as a time series.

5. The system of claim 1, comprising the data processing system to:
receive a first data feed of the plurality of data feeds as a time series; and
receive a second data feed of the plurality of data feeds as a cross-sectional data.

6. The system of claim 1, wherein the plurality of data feeds comprise at least one of weather forecast data, farm management data, livestock management data, biosphere data, biodiversity data, property data, river height data, or dam height data.

7. The system of claim 1, comprising:
the data processing system to tag the normalized data set with a geospatial identifier and a temporal identifier.

8. The system of claim 1, comprising the data processing system to:
receive, via a network from a device remote from the data processing system, a query to generate a metric indicative of performance of the farm;
select, responsive to the query, a function to generate the metric;
apply the function to the normalized data set to generate the metric; and
provide, for display via the device, the metric.

9. The system of claim 1, comprising the data processing system to:
receive, via a network from a device remote from the data processing system, a query data structure comprising a geospatial component and a temporal component;
identify, for the query data structure, a function comprising inputs corresponding to at least two of the plurality of data feeds;
select, for input into the function and based on the query data structure, one or more portions of the normalized data set;
execute the function with the selected one or more portions of the normalized data set to generate a response to the query; and
provide, for display via the device, the response to the query generated via execution of the function with the selected one or more portions of the normalized data set.

10. The system of claim 1, comprising the data processing system to:
select a function configured to determine a disease risk for a crop of the farm;
determine one or more geospatial and temporal inputs for the function;
access, from the normalized data set, data corresponding to the one or more geospatial and temporal inputs for the function;
input the data into the function to generate a metric corresponding to the disease risk for the crop of the farm; and
provide, for display via a device, the metric.

11. A method of convergence based agricultural actions via a data pipeline, comprising:
receiving, by a data processing system comprising one or more processors coupled with memory, for storage in a buffer, raw data from a plurality of data feeds that are indicative of performance of agriculture on a farm;
tagging, by the data processing system prior to execution of a data translation process, the raw data with a plurality of identifiers;
executing, by the data processing system with the raw data maintained in the buffer, the data translation process to map the raw data from a first one or more shapes into a second shape to generate a normalized data set;
detecting, by the data processing system, an error in a portion of the normalized data set;
determining, by the data processing system responsive to detection of the error, an identifier of the plurality of identifiers tagged to a portion of the raw data in the buffer that corresponds to the portion of the normalized data set with the error; and
updating, by the data processing system via a second data translation process on the portion of the raw data in the buffer that corresponds to the portion of the normalized data set with the error, the normalized data set to remove the error.

12. The method of claim 11, comprising:
receiving, by the data processing system, the plurality of data feeds generated by a plurality of sensors comprising at least one of a precipitation sensor, a temperature sensor, a light sensor, a humidity sensor, a wind sensor, or a soil moisture probe.

13. The method of claim 11, comprising:
receiving, by the data processing system, a first data feed of the plurality of data feeds as a time series; and
receiving, by the data processing system, a second data feed of the plurality of data feeds as a cross-sectional data.

14. The method of claim 11, wherein the plurality of data feeds comprise at least one of weather forecast data, farm management data, livestock management data, biosphere data, biodiversity data, property data, river height data, or dam height data.

15. The method of claim 11, comprising:
tagging, by the data processing system, the normalized data set with a geospatial identifier and a temporal identifier.

16. The method of claim 11, comprising:
receiving, by the data processing system via a network from a device remote from the data processing system, a query to generate a metric indicative of performance of the farm;
selecting, by the data processing system responsive to the query, a function to generate the metric;
applying, by the data processing system, the function to the normalized data set to generate the metric; and
providing, by the data processing system for display via the device, the metric.

17. The method of claim 11, comprising:
receiving, by the data processing system via a network from a device remote from the data processing system, a query data structure comprising a geospatial component and a temporal component;
identifying, by the data processing system for the query data structure, a function comprising inputs corresponding to at least two of the plurality of data feeds;
selecting, by the data processing system for input into the function and based on the query data structure, one or more portions of the normalized data set;
executing, by the data processing system, the function with the selected one or more portions of the normalized data set to generate a response to the query; and
providing, by the data processing system for display via the device, the response to the query generated via execution of the function with the selected one or more portions of the normalized data set.

18. The method of claim 11, comprising:
selecting, by the data processing system, a function configured to determine a disease risk for a crop of the farm;
determining, by the data processing system, one or more geospatial and temporal inputs for the function;
accessing, by the data processing system from the normalized data set, data corresponding to the one or more geospatial and temporal inputs for the function;
inputting, by the data processing system the data into the function to generate a metric corresponding to the disease risk for the crop of the farm; and
providing, by the data processing system for display via a device, the metric.

19. A non-transitory computer readable medium storing processor executable instructions for convergence based agricultural actions via a data pipeline that, when executed by one or more processors, cause the one or more processors to:
receive, for storage in a buffer, raw data from a plurality of data feeds that are indicative of performance of agriculture on a farm;
tag, prior to execution of a data translation process, the raw data with a plurality of identifiers;
execute, with the raw data maintained in the buffer, the data translation process to map the raw data from a first one or more shapes into a second shape to generate a normalized data set;
detect an error in a portion of the normalized data set;
determine, responsive to detection of the error, an identifier of the plurality of identifiers tagged to a portion of the raw data in the buffer that corresponds to the portion of the normalized data set with the error; and
update, via a second data translation process on the portion of the raw data in the buffer that corresponds to the portion of the normalized data set with the error, the normalized data set to remove the error.

20. The non-transitory computer readable medium of claim 19, wherein the instructions further comprise instructions to:
receive the plurality of data feeds generated by a plurality of sensors comprising at least one of a precipitation sensor, a temperature sensor, a light sensor, a humidity sensor, a wind sensor, or a soil moisture probe.
